(19) United States
(12) Patent Application Publication
(10) Pub. No.: US 2016/0361645 A1
(43) Pub. Date: Dec. 15, 2016

(54) METHOD AND SYSTEM FOR EVALUATING GAME CONTENT

(71) Applicant: Next Floor Corp., Seoul (KR)

(72) Inventor: Min Kyu KIM, Yongin-si (KR)

(21) Appl. No.: 14/926,965

(22) Filed: Oct. 29, 2015

(30) Foreign Application Priority Data
Jun. 10, 2015 (KR) 10-2015-0082155

(51) Int. Cl. A63F 13/35; A63F 13/53; A63F 13/95; A63F 13/46

(52) U.S. Cl. CPC A63F 13/35; A63F 13/46; A63F 13/53; A63F 13/95

(57) ABSTRACT

The present invention relates to a method for evaluating game content in an online game, and the method comprises: receiving evaluation information for game content from a first game device; updating evaluation data for the game content in a game content evaluation database based on the received evaluation information for the game content; receiving a evaluation data request from a second game device; reading the evaluation data for the game content from the game content evaluation database; and transmitting the read evaluation data for the game content to the second game device.

### CROSS-REFERENCE TO RELATED APPLICATION(S)

This application is based on and claims priority from Korean Patent Application No. 10-2015-0082155, filed on Jun. 10, 2015, with the Korean Intellectual Property Office, the disclosure of which incorporated herein in its entirety by reference.

### BACKGROUND

Technical Field

The present invention relates to an online game.

Description of the Related Art

The advance of smartphone technology recently brought an explosion of the online game user (gamer) population. In general, descriptions about game contents provided in the game itself tend to be simple and limited, which makes the users spend a long time playing and repeating trial and error to figure out specific information or knowhow about the game contents, for example, characters, pets, and items. Moreover, it may be difficult to share the information and knowhow acquired in such a way with other users. Accordingly, it is desirable to have a system which enables the users to easily share the information about game contents with each other inside the game program while playing the game.

### BRIEF SUMMARY

A method performed by a game server for evaluating game content according to an embodiment of the present disclosure may include: receiving evaluation information for the game content from a first game device; updating evaluation data for the game content in a game content evaluation database based on the received evaluation information for the game content; receiving an evaluation data request for the game content from a second game device; reading the evaluation data for the game content from the game content evaluation database; and transmitting the read evaluation data for the game content to the second game device.

The present disclosure describes techniques for addressing the problems described above including to provide a system and method for evaluating game content.

A method performed by a game server for evaluating game content according to an embodiment of the present disclosure may include receiving evaluation information for game content from a first game device; updating evaluation data for the game content in a game content evaluation database based on the received evaluation information for the game content; receiving an evaluation data request for the game content from a second game device; reading the evaluation data for the game content from the game content evaluation database; and transmitting the read evaluation data for the game content to the second game device.

The game content may include at least one of a game character, a pet, and an item.

The evaluation information for the game content and the evaluation data for the game content may include a comment on the game content.

The evaluation information for the game content may include a score of the game content.

The evaluation data for the game content may include an overall rating of the game content, and the overall rating of the game content may be calculated based on scores of the game contents received from a plurality of game devices.

The evaluation data for the game content may include evaluation data for a field of the evaluation data for the game content, and may further include receiving evaluation information for the field of the evaluation data for the game content from the second game device; and updating the evaluation data for the field of the evaluation data for the game content in the game content evaluation database based on the received evaluation information for the field of the evaluation data for the game content.

The evaluation information for the field of the evaluation data for the game content may include whether the field of the evaluation data for the game content is recommended.

The evaluation data for the field of the evaluation data for the game content may include a number of recommendations on the field of the evaluation data for the game content.

A method performed by a game device for evaluating game content according to an embodiment of the present disclosure may include receiving evaluation information for game content from a user; transmitting the evaluation information for the game content to a game server; receiving a request for displaying the evaluation data for the game content from the user; transmitting a request for the evaluation data for the game content to the game server; receiving the evaluation data for the game content from the game server; and displaying the received evaluation data for the game content.

The evaluation information for the game content transmitted from another game device may also be reflected in the evaluation data for the content.

The game content may include at least one of a game character, a pet, and an item.

The evaluation information for the game content and the evaluation data for the game content may include a comment on the game content.

The evaluation information for the game content may include a score of the game content.

The evaluation data for the game content may include an overall rating of the game content.

The evaluation data for the game content may include evaluation data for a field of the evaluation data for the game content, and may further include receiving evaluation information for the field of the evaluation data for the game content from a user; and transmitting the received evaluation information for the field of the evaluation data for the game content to the game server.

The evaluation information for the field of the evaluation data for the game content may include whether the field of the evaluation data for the game content is recommended.

The evaluation data for the field of the evaluation data for the game content may include a number of recommendations on the field of the evaluation data for the game content.

The embodiment may also include receiving a game content evaluation data display criterion from the user; and displaying the received evaluation data for the game content according to the received game content evaluation data display criterion. The game content evaluation data display criterion may include at least one of: newest to oldest, recommended-accumulated, recommended-recent, and my comments.

The displaying of the received evaluation data for the game content may include displaying the evaluation data only for the game content among a plurality of game contents.

Receiving of the evaluation information for the game content from the user may be performed by receiving an evaluation information input command from the user while a game contents list page, a detailed information page of the game content, or an evaluation data display page for the game content is displayed.

A game server according to an embodiment of the present disclosure may have a communication unit to communicate with a game device; and a control unit configured to receive evaluation information for game content from a first game device through the communication unit; update evaluation data for the game content in a game content evaluation database based on the received evaluation information for the game content; receive an evaluation data request for the game content from a second game device through the communication unit; read the evaluation data for the game content from the game content evaluation database; and transmit the read evaluation data for the game content to the second game device through the communication unit.

The game content may include at least one of a game character, a pet, and an item.

The evaluation information for the game content and the evaluation data for the game content may include a comment on the game content.

The evaluation information for the game content may include a score of the game content.

The evaluation data for the game content may include an overall rating of the game content, and the overall rating of the game content may be calculated based on scores of the game content received from a plurality of game devices.

The evaluation data for the game content may include evaluation data for a field of the evaluation data for the game content, and the control unit may be further configured to receive evaluation information for the field of the evaluation data for the game content from the second game device through the communication unit and update the evaluation data for the field of the evaluation data for the game content in the game content evaluation database based on the received evaluation information for the field of the evaluation data for the game content.

The evaluation information for the field of the evaluation data for the game content may include whether the field of the evaluation data for the game content is recommended.

The evaluation data for the field of the evaluation data for the game content may include a number of recommendations on the field of the evaluation data for the game content.

A game device according to an embodiment of the present disclosure may have a communication unit to communicate with a game server; an input unit to receive an user input; a display unit to display data; and a control unit configured to: receive evaluation information for game content from a user through the input unit; transmit the evaluation information for the game content to the game server through the communication unit; receive a request for displaying the evaluation data for the game content from the user through the input unit; transmit a request for the evaluation data for the game content to the game server through the communication unit; receive the evaluation data for the game content from the game server through the communication unit; and display the received evaluation data for the game content through the display unit.

The evaluation information for the game content transmitted from another game device may also be reflected in the evaluation data for the game content.

The present disclosure may include a computer program stored on a medium to execute a method according to an embodiment.

The present disclosure may include a non-transitory computer-readable storage medium having a program to perform a method according to an embodiment stored thereon.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a schematic view showing a game content evaluating system according to an embodiment.

FIG. 2 is a sequence diagram showing a schematic flow of a game content evaluating method according to an embodiment.

FIG. 3 is an exemplary screen on which user-input comments on a particular game content are displayed accumulatively in a game content evaluating system according to an embodiment.

FIG. 4 is a diagram showing the input flow of a comment on game content according to an embodiment.

FIG. 5 is a diagram showing the input flow of a star rating of game content according to an embodiment.

FIG. 6 is a diagram showing the input flow of “recommend/not recommend” on a comment on game content according to an embodiment.

FIG. 7 is a diagram showing the input flow of a display criterion for evaluation data for game content according to an embodiment.

FIG. 8 is a sequence diagram showing a more specific update flow of evaluation data for game content according to an embodiment.

FIG. 9 is a sequence diagram showing a more specific display flow of evaluation data for game content according to an embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented herein.

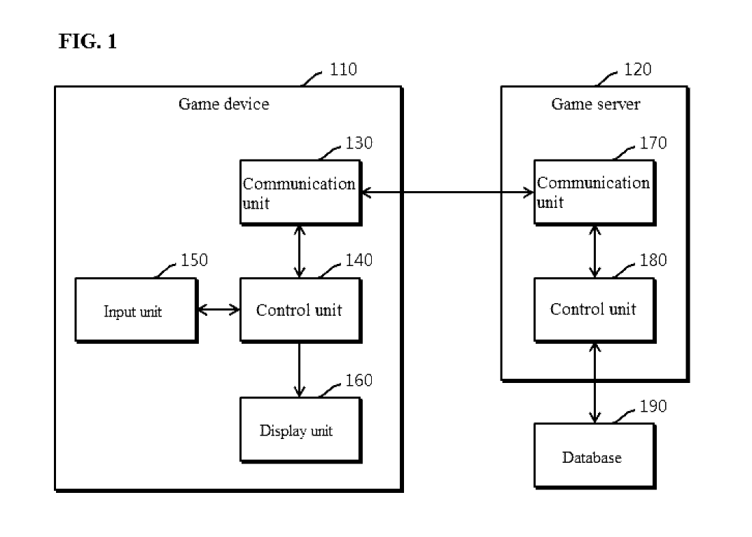

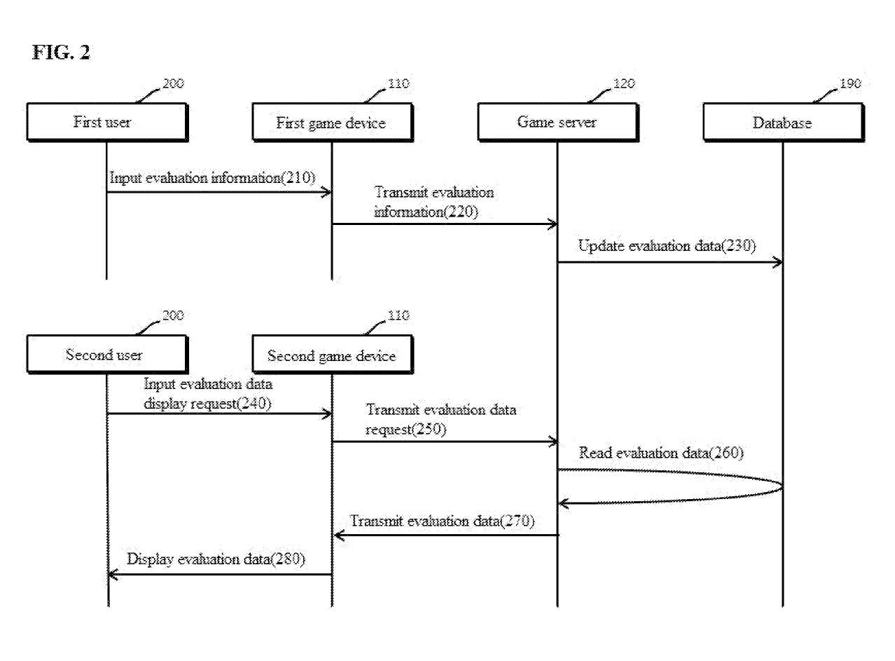

FIG. 1 is a schematic view showing a game content evaluating system according to an embodiment. Referring to FIG. 1, the game content evaluating system according to an embodiment includes a game device 110 and a game server 120 communicating with each other via electronic communications transmitted over one or more wired and/or wireless network connections. In the depicted embodiment, game device 110 is a device on which an online game client program is running, which includes a communication unit 130, a control unit 140, an input unit 150, and a display unit 160. Game server 110 is a device on which an online game server program is running, which includes a communication unit 170, and a control unit 180. In addition, the game device 110 and game server 120 each include one or more hardware CPU processors, a network connection via the respective communication units 130 and 170, and may additionally include various I/O components (e.g., input keys, a keyboard, mouse, speakers, etc.), storage, and memory, but such components are not illustrated in this example for the sake of brevity. The game device and the game server communicate with each other via respective communication units 130 and 170. Control unit 140 of the game device receives an input from a user (gamer) through input unit 150 and displays information to the user through display unit 160. Depending on the embodiment, a single unit in which the input and display units are combined, such as a touchscreen, can be used. The game server manages data using a game content evaluation database 190, and the game content evaluation database may be incorporated into the game server depending on the embodiment. The respective control units 140 and 180 work together with the communication unit 130, input unit 150, display unit 160, and database 190, and so on, which will be described below with reference to FIG. 2.

It will be appreciated that game device 110 and game server 120 are merely illustrative and are not intended to limit the scope of embodiments of the present disclosure. Each of game device 110 and game server 120 may instead be executed by multiple interacting computing systems or devices, and may be connected to other devices that are not illustrated, including through one or more networks such as the Internet, via the World Wide Web (“Web”), or other electronic communications network. More generally, a “client” or “server” computing system or device may comprise any combination of hardware and/or firmware that can interact in the described manners, optionally when programmed or otherwise configured with particular software, including (without limitation) desktop or other computers, network devices, PDAs, cell phones, wireless phones, electronic organizers, Internet appliances, television-based systems, game consoles, media players and various other consumer products that include appropriate inter-communication capabilities. In addition, the functionality described may in some embodiments be provided via various modules, as noted above, or optionally may be separated into different (e.g., more or less) modules than are illustrated.

FIG. 2 is a sequence diagram showing a schematic flow of a game content evaluating method according to an embodiment. Referring to FIG. 2, the game content evaluating method according to the depicted embodiment includes a process 210-230 for storing or updating evaluation data for game content in a game content evaluation database 190 with evaluation information for the game content which is input by a user 200 in the online game and a process 240-280 for displaying the evaluation data for the game content stored in game content evaluation database 190 to a user in the online game. Here, the game content means various game elements such as game characters, pets, items, and so on. The evaluation information for the game content is information in which a user evaluates a particular game content, which may include: an opinion, in which a user thinks or feels about the game content; an explanation for the content; a comment, which may be a textual description about knowhow and the like for the content obtained through game play; or score, in which a performance, usability, and/or other aspects of the content may be expressed as a numerical, graphical or other rating.

With regard to the evaluation data update process, control unit 140 of the first game device receives evaluation information for the game content, from a user 200 through input unit 150 (step 210) and transmits the evaluation information for the game content to the game server through communication unit 130 (220). Control unit 180 of the game server updates the evaluation data for the game content in game content evaluation database 190 based on the evaluation information for the game content received from the first game device through communication unit 170 (step 230).

If the evaluation information input by the user is a comment on the game content, the comment may be stored in the evaluation data for the game content in the database, or an existing comment may be deleted and replaced by the new comment. If the evaluation information input by the user is a score of the game content, the score may be stored or updated in the evaluation data for the game content in the database. Also, an overall rating may be calculated based on the scores of the game content received from a plurality of game devices, and stored or updated in the evaluation data for the game content in the database. The overall rating may be calculated by averaging all scores or by alternative algorithms.

With regard to the evaluation data display process, control unit 140 of the second game device receives a request for displaying the evaluation data for the game content from a user through input unit 150 (step 240) and transmits a request for evaluation data for the game content to the game server through communication unit 130 (step 250). Control unit 180 of the game server receives the request for the evaluation data for the game content from the second game device through communication unit 170, reads the evaluation data for the game content from the game content evaluation database (step 260), and transmits the read evaluation data for the game content to the second game device through communication unit 170 (step 270). Control unit 140 of the second game device which received the evaluation data for the game content from the game server through communication unit 150 displays the received evaluation data for the game content in the online game through the display unit 160 (step 280). In general, there may be a wide variety of content in the game, and control unit 140 of the second game device may only display the evaluation data for a specific one of the contents for which the user requested to display the evaluation data, so that the user can easily identify the information specific to the desired content.

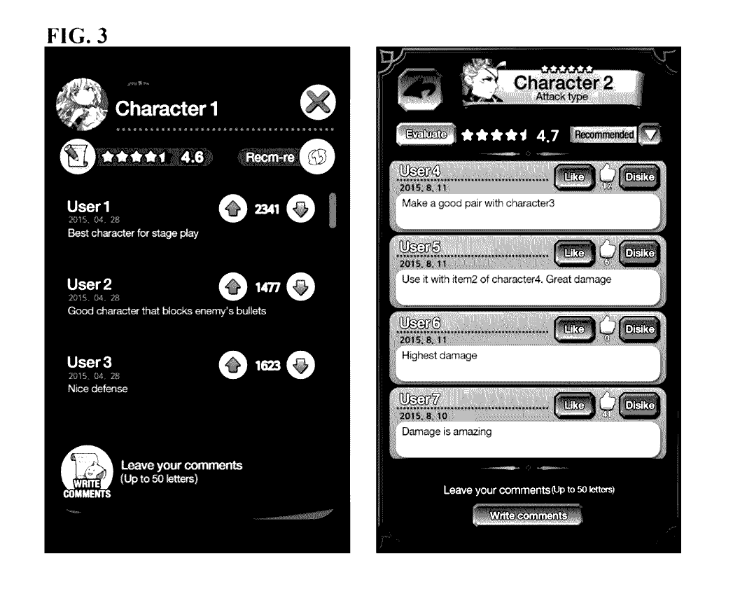

In this way, the evaluation information for the game content transmitted from the first game device may be reflected in the evaluation data in the database, and the second game device receives and displays the evaluation data for the game content, so that the evaluation information for the specific game content can be shared among different users. Since the evaluation data in the database may reflect evaluation information received from a number of game devices such as a third and a fourth game devices, and so on, the evaluation information from a large number of users can be accumulated and shared with each other. For example, as shown in FIG. 3, if the user-input comments on a particular game content are displayed accumulatively, a discussion or questions and answers may be conducted between the users with respect to the game content. These information sharing, discussions, questions and answers, and so on between users are especially helpful for novice users who are unfamiliar with the various game elements, and may have the nature of user community to form solidarity between the users. In particular, since the users playing the game by themselves may continuously add and modify the evaluation data in real time, it is possible to flexibly cope with changes in the contents or system of the game, which may be a great advantage.

FIG. 2 shows an embodiment in which the evaluation data reflecting the evaluation information input from the first game device is received and displayed by the second game device. In other embodiments, it is possible to receive and display the evaluation data reflecting the evaluation information input from the first game device by the same first game device. Further, the user may be identified by the game device, or by a login method using a user ID of the game operator, Kakao account, Facebook UID, and so on.

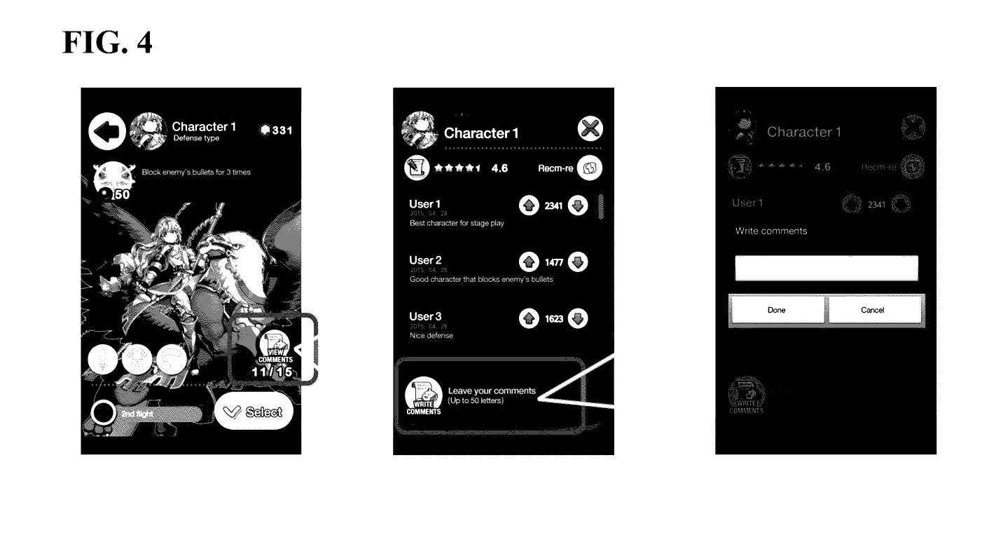

FIG. 4 is a diagram showing the input flow of a comment on game content according to one embodiment. Referring to FIG. 4, from the detailed information page of each game content, a user can enter into the comment view page, i.e., the evaluation data display page for the game content, and input a comment. Thus, reading and writing comments inside the game is made possible, which may keep the participation rate of users very high. Depending on the embodiment, a comment can be directly input in the detailed information page of each game content, or in the game contents list page.

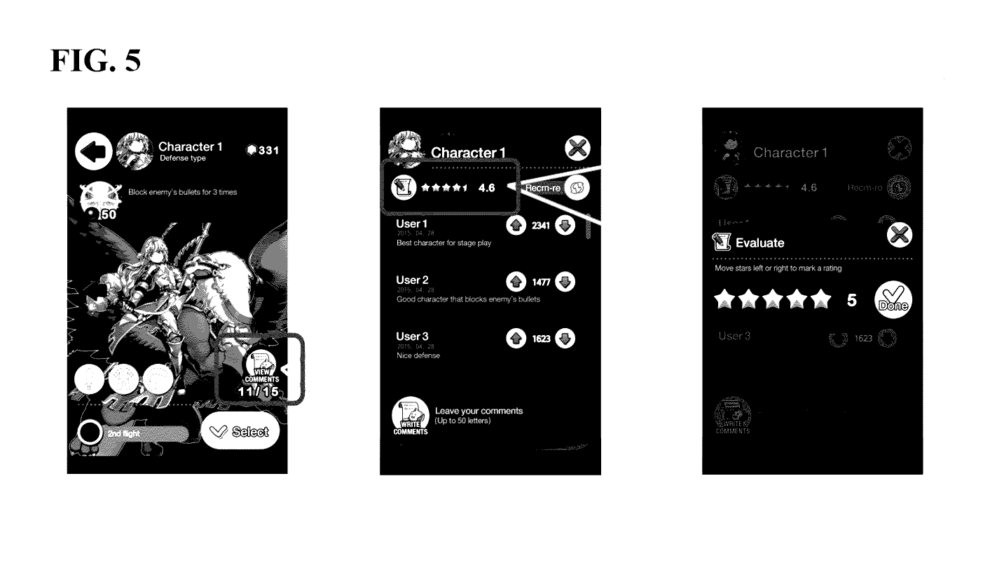

Also, as shown in FIG. 5, an overall rating of the game content may be calculated on the basis of the star ratings which users marked on a specific game content and shared between the game users. This may be the factor by which a user can determine the performance of the game content most intuitively, and may be particularly helpful for novice users who are not familiar with a variety of game contents.

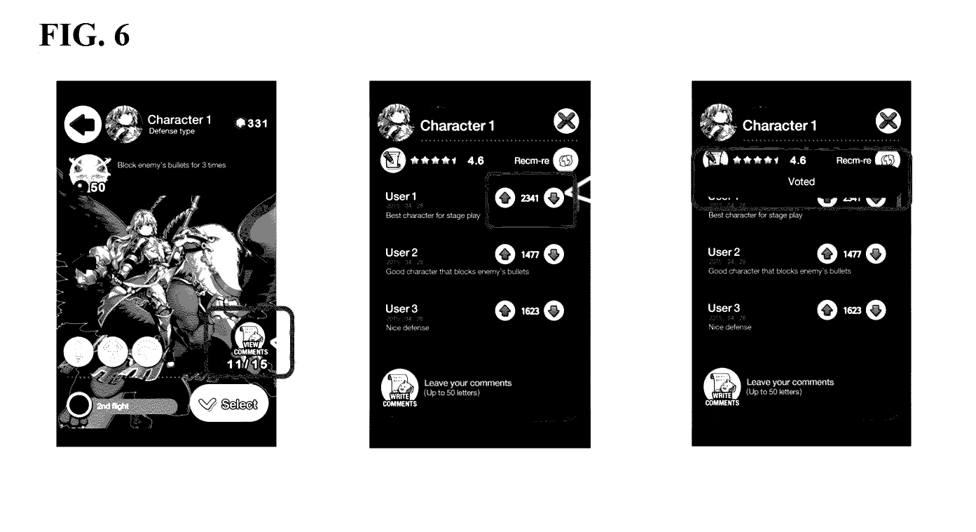

Further, as shown in FIG. 6, a user can evaluate the evaluation for the game content itself as well as the game content by inputting “recommend/not recommend” or “like/dislike” for the evaluation data displayed by the display unit 160. That is, the evaluation data for the game content stored in the database 190 may include evaluation data for a specific field of the evaluation data itself. Control unit 140 of the game device receives evaluation information for a field of the evaluation data for the game content, and transmits the received evaluation information for the field of the evaluation data for the game content to the server through communication unit 130. Control unit 180 of the game server receives the evaluation information for the field of the evaluation data for the game content from the game device through communication unit 170, and updates the evaluation data for the field of the evaluation data for the game content in the game content evaluation database based on the received evaluation information for the field of the evaluation data for the game content. Here, the evaluation information for the field of the evaluation data for the game content input from the user may include “recommend” or “not recommend” for the field of the evaluation data for the game content. The evaluation data for the field of the evaluation data for the game content which is stored/updated in the database may include the number of “recommend”, the number of “not recommend”, or the difference between the numbers of “recommend” and “not recommend”, and so on with regard to the field of the evaluation data for the game content.

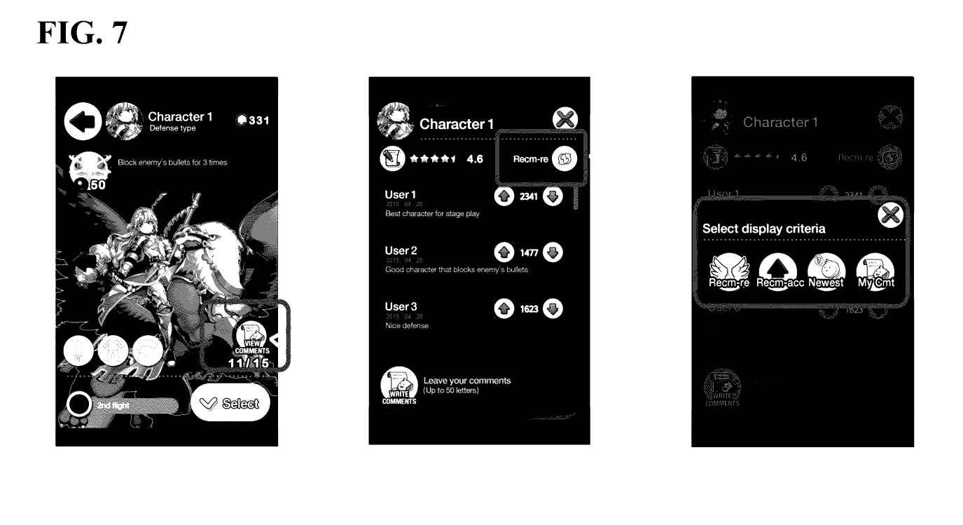

In addition, as shown in FIG. 7, a user may select a display criterion for the evaluation data for the game content. That is, control unit 140 of the game device receives a game content evaluation data display criterion from a user through input unit 150, and displays the evaluation data for the game content through display unit 160 according to the input game content evaluation data display criterion. Here, the game content evaluation data display criteria may include “newest to oldest”, “recommended-accumulated”, “recommended-recent”, or “my comments”, and so on. Among these criteria, “newest to oldest”, “recommended-accumulated”, and “recommended-recent” are to decide the display order of the evaluation data, and “my comments” may be limited to display only the user's own comments. In particular, as “recommended-accumulated” and “recommended-recent” criteria work together with the evaluation data recommendation feature described with reference to FIG. 6, users can filter bad or false opinions by themselves and easily look up good or important opinions.

Furthermore, the game administrators may also read the comments stored in the database. Accordingly, users may enter suggestions or complaints about a specific game content, and the game administrators may identify and consider suggestions or complaints of consensus among users in accordance with the recommendation feature for the comment to help improve the services.

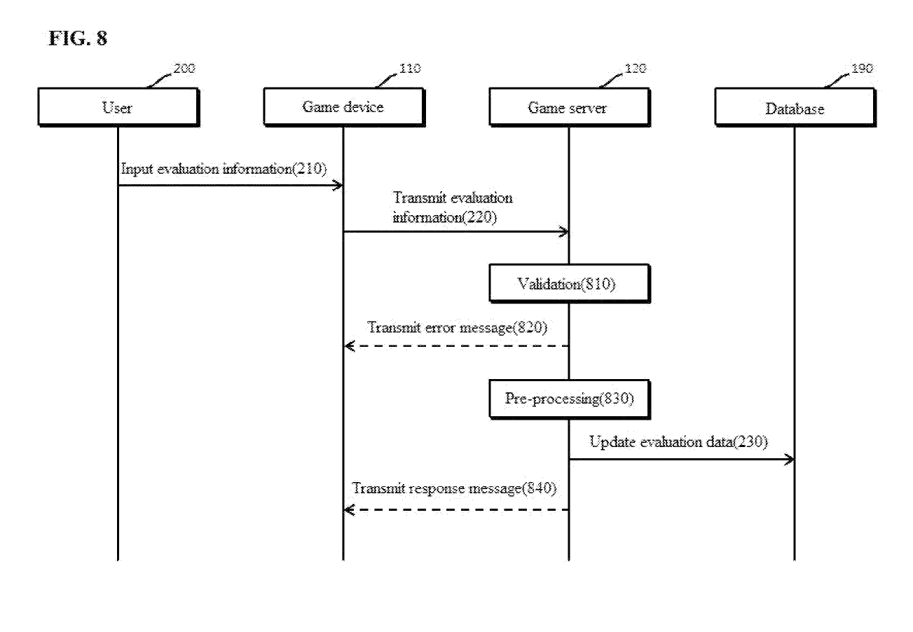

FIG. 8 is a sequence diagram showing a more specific update flow of the evaluation data for the game content according to an embodiment. As compared to FIG. 2, FIG. 8 further includes validation 810, error message transmission 820, pre-processing 830, and response message transmission 840. Validation 810 is to determine whether the ID of the user and the game content are correct. Additionally, various settings for evaluation information input such as language code or nickname can be checked during validation 810. If an error occurs during the validation, the game server may transmit an error message to the game device (step 820). Pre-processing 830 is to perform necessary processing before updating the evaluation data in the database, which may include determining whether the user has ever input evaluation information for the content before and whether the existing evaluation information should be replaced with the new evaluation information or the new evaluation information would be stored additionally, and processing in accordance with the determination. The game server may send a response message to the game device after updating the evaluation data in the database (step 840).

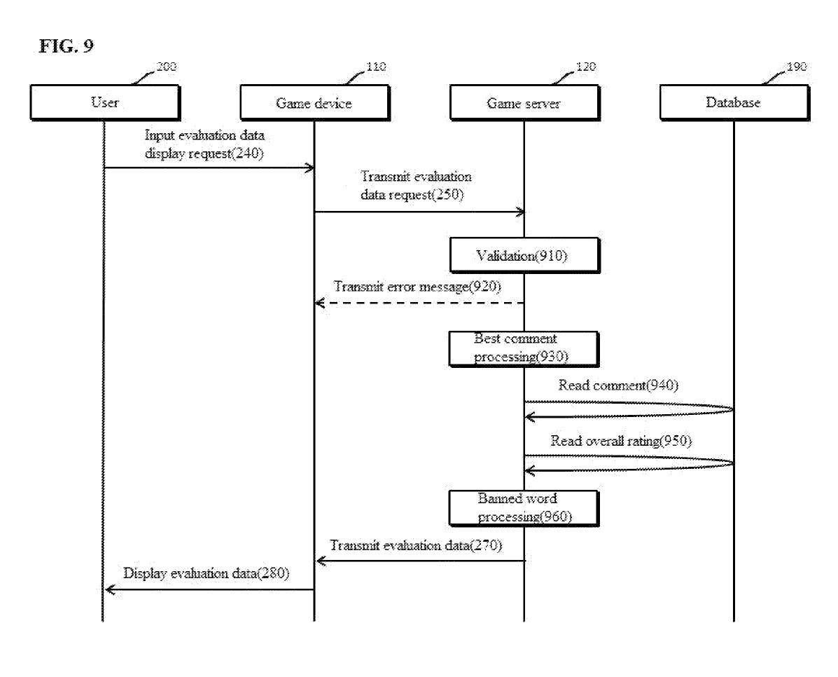

FIG. 9 is a sequence diagram showing a more specific display flow of the evaluation data for the game content according to an embodiment. As compared to FIG. 2, FIG. 9 further includes validation 910, error message transmission 920, best comment processing 930, and banned word processing 960. Also, evaluation data reading 260 of FIG. 2 is performed more specifically as comment reading 940 and overall rating reading 950. Validation 910 is similar to validation 810, in which it may be determined whether the ID of the user and the game content are correct. If an error occurs during the validation, the game server may transmit an error message to the game device (step 920). Best comment processing 930 is to perform processes for lining up and reading the comments according to the evaluation data display criterion such as “newest to oldest”, “recommended-recent”, and so on. Comment reading 940 is to read the comments by pages from the database according to the order in which the comments are lined up. Overall rating reading 950 is to read an overall rating on the content from the database. Banned word processing 960 is to filter the banned words such as abuse languages in the comments.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a game server for evaluating game content, the method comprising:
receiving, by the game server via one or more first electronic communications sent over one or more computer networks from a first game device, evaluation information for the game content indicated by a first user associated with the first game device;
updating, by the game server and based at least in part on the received evaluation information for the game content, stored evaluation data for the game content in a game content evaluation database;
receiving, by the game server via one or more second electronic communications sent over the one or more computer networks from a second game device, an evaluation data request for the game content initiated by a distinct second user associated with the second game device;
retrieving, by the game server, at least some of the updated evaluation data for the game content from the game content evaluation database; and
transmitting, by the game server via one or more third electronic communications sent over the one or more computer networks to the second game device, the at least some of the retrieved devaluation data for the game content.

2. The method of claim 1, wherein at least one of the evaluation information for the game content or the evaluation data for the game content include a comment on the game content.

3. The method of claim 1, wherein the evaluation information for the game content includes a score of the game content.

4. The method of claim 3, wherein the evaluation data for the game content includes an overall rating of the game content; and
wherein the overall rating of the game content is determined based at least in part on scores of the game content that are received from a plurality of game devices.

5. The method of claim 1, wherein the evaluation data for the game content includes evaluation data for a field of the evaluation data for the game content; and
wherein the method further comprises:
receiving, via one or more additional electronic communications sent over the one or more computer networks from the second game device, evaluation information for the field of the evaluation data for the game content; and
updating the evaluation data for the field of the evaluation data for the game content in the game content evaluation database based at least in part on the received evaluation information for the field of the evaluation data for the game content.

6. The method of claim 5, wherein the evaluation information for the field of the evaluation data for the game content includes an indication of whether the field of the evaluation data for the game content is recommended.

7. The method of claim 6, wherein the evaluation data for the field of the evaluation data for the game content includes an indication of a quantity of recommendations on the field of the evaluation data for the game content.

8. A method performed by a game device for evaluating game content, comprising:
receiving, by the game device via one or more first electronic communications initiated by a user, evaluation information for the game content;
transmitting, by the game device via one or more second electronic communications and one or more computer networks, the evaluation information for the game content to a game server;
receiving, by the game device via one or more third electronic communications and the one or more computer networks, a request for displaying evaluation data for the game content, the evaluation data being based at least in part on the evaluation information from the user;
transmitting, by the game device via one or more fourth electronic communications sent over the one or more computer networks, a request for the evaluation data for the game content to the game server;
receiving, by the game device via one or more fifth electronic communications sent over the one or more computer networks, the evaluation data for the game content from the game server; and
causing, by the game device via at least one or more sixth electronic communications, at least one display device to display the received evaluation data for the game content.

9. The method of claim 8, wherein receiving the evaluation data for the game content from the game server includes receiving evaluation data based at least in part on evaluation information for the game content transmitted from another game device.

10. The method of claim 8, wherein the evaluation data for the game content includes evaluation data for a field of the evaluation data for the game content; and wherein the method further comprises:
receiving evaluation information for the field of the evaluation data for the game content from a user; and
transmitting the received evaluation information for the field of the evaluation data for the game content to the game server.

11. The method of claim 8, further comprising:
receiving a game content evaluation data display criterion from the user; and
displaying the received evaluation data for the game content according to the received game content evaluation data display criterion,
wherein the game content evaluation data display criterion includes at least one of: newest to oldest, recommended-accumulated, recommended-recent, or my comments.

12. The method of claim 8, wherein the displaying of the received evaluation data for the game content includes displaying the evaluation data only for the game content among a plurality of game contents.

13. A game server comprising:
a communication unit to communicate with one or more game devices; and
a control unit configured to:
receive, via the communication unit and one or more first electronic communications sent over one or more computer networks from a first game device, evaluation information for game content;
update evaluation data for the game content in a game content evaluation database based at least in part on the received evaluation information for the game content;
receive, via the communication unit and one or more second electronic communications sent over the one or more computer networks from a second game device, an evaluation data request for the game content;
retrieve, based at least in part on the received evaluation data request and via one or more third electronic communications, the updated evaluation data for the game content from the game content evaluation database; and
transmit, via the communication unit and one or more fourth electronic communications sent over the one or more computer networks to the second game device, the read evaluation data for the game content.

14. The game server of claim 13, wherein the control unit is a hardware-based control unit, wherein the evaluation data for the game content includes evaluation data for a field of the evaluation data for the game content; and
wherein the hardware-based control unit is further configured to:
receive evaluation information for the field of the evaluation data for the game content from the second game device through the communication unit; and
update the evaluation data for the field of the evaluation data for the game content in the game content evaluation database based on the received evaluation information for the field of the evaluation data for the game content.

15. A game device comprising:
a communication unit that, in operation, communicates with a game server;
an input unit that, in operation, receives user input;
a display unit that, in operation, displays data; and
a control unit that, in operation:
receives evaluation information for game content from a user through the input unit;
transmits, via the communication unit and one or more first electronic communications sent over one or more computer networks, the evaluation information for the game content to the game server;
receives, via the input unit and one or more second electronic communications sent over the one or more computer networks, a request for displaying the evaluation data for the game content from a user;
transmits, via the communication unit and one or more third electronic communications sent over the one or more computer networks, a request for the evaluation data for the game content to the game server;
receives, via the communication unit and one or more fourth electronic communications sent over the one or more computer networks, the evaluation data for the game content from the game server; and
display, via the display unit, the received evaluation data for the game content.

16. The game device of claim 15, wherein the control unit is a hardware control unit and wherein evaluation information for the game content transmitted from another game device is reflected in the evaluation data for the game content.

17. A non-transitory computer-readable storage medium having contents that, when executed, cause a game server to at least:
receive, via one or more first electronic communications sent over one or more computer networks from a first game device, evaluation information for game content;
update stored evaluation data for the game content in a game content evaluation database based at least in part on the received evaluation information for the game content;
receive, via one or more second electronic communications sent over the one or more computer networks from a second game device, an evaluation data request for the game content;
retrieve at least some of the stored evaluation data for the game content from the game content evaluation database; and
transmit, via one or more third electronic communications sent over the one or more computer networks to the second game device, the at least some of the retrieved evaluation data for the game content.

18. The non-transitory computer-readable storage medium of claim 17, wherein the evaluation data for the game content includes evaluation data for a field of the evaluation data for the game content, and wherein the stored contents, when executed, further cause the game server to:
receive, via one or more additional electronic communications sent over the one or more computer networks from the second game device, evaluation information for the field of the evaluation data for the game content; and
update the evaluation data for the field of the evaluation data for the game content in the game content evaluation database based at least in part on the received evaluation information for the field of the evaluation data for the game content.

19. A non-transitory computer-readable storage medium having contents that, when executed, cause a game device to at least:
receive, via one or more first electronic communications sent over one or more computer networks from a client computing device associated with a user, evaluation information for game content;
transmit, via one or more second electronic communications sent over the one or more computer networks, the evaluation information for the game content to a game server;
receive, via one or more third electronic communications sent over the one or more computer networks from the client computing device of the user, a request for displaying the evaluation data for the game content;
transmit, via one or more fourth electronic communications sent over the one or more computer networks, a request for the evaluation data for the game content to the game server;
receive, via one or more fifth electronic communications sent over the one or more computer networks, the evaluation data for the game content from the game server; and
display, via a display device and at least one or more sixth electronic communications, the received evaluation data for the game content.

20. The non-transitory computer-readable storage medium of claim 19, wherein the evaluation data for the game content includes evaluation data for a field of the evaluation data for the game content.
